(19) United States
(12) Patent Application Publication
(10) Pub. No.: US 2003/0004302 A1
(43) Pub. Date: Jan. 2, 2003

(54) Process for producing purified polyether sulfones

(76) Inventors: Satoshi Okamoto, Tsukuba-shi (JP); Noriaki Saito, Osaka (JP); Toshiaki Hayashi, Tsukuba-shi (JP)

Correspondence Address: BIRCH STEWART KOLASCH & BIRCH, PO BOX 747, FALLS CHURCH, VA, 22040-0747, US

(21) Appl. No.: 10/142,777

(22) Filed: May 13, 2002

(30) Foreign Application Priority Data
May 15, 2001 (JP) 2001-144301

(51) Int. Cl. C08G 75/00

(52) U.S. Cl. 528/373

(57) ABSTRACT

A process for producing a purified polyether sulfone which comprises bringing a solution of a crude polyether sulfone in an organic solvent in contact with an adsorbent.

### FIELD OF THE INVENTION

The present invention relates to a process for producing a purified polyether sulfone. More precisely, the invention relates to a process for producing a purified polyether sulfone by use of an adsorbent.

### BACKGROUND OF THE INVENTION

Polyether sulfones are super engineering plastics useful in the field of electric and electronic parts and others. In recent years, there is a rapid rise in the demands thereof in the field of electric and electronic parts including circuit boards, supporting substrate for discs such as optical discs, magnetic discs and the like, electrical insulating protective films, insulating films for multilayer boards, interlaminer insulating films for integrated circuits and the like, making use of their excellent thermal resistance, mechanical properties, electric properties, molding stability, processability, optical properties and so on.

As processes for producing the polyether sulfones, processes have been known in which a di-alkali metal salt of a bivalent phenol compound is reacted with a dihalogenodiphenyl sulfone in an organic solvent (JP-B-42-7799, JP-B-45-21318 and JP-A-48-19700). Reaction masses obtained by these processes contain, beside polyether sulfones, inorganic substances such as alkali metal halide compounds, unreacted alkali metal compounds and the like. Therefore, there have been known a process for producing a crude polyether sulfone in which these inorganic substances are removed from the reaction mass by filtration or centrifugation and then a polyether sulfone is separated by precipitation with addition of a poor solvent, and a process for producing a crude polyether sulfone in which a polyether sulfone is precipitated by adding a poor solvent to the reaction mass and then inorganic substances are removed by washing with water or like means, and others.

As processes for producing pure polyether sulfones, there have been proposed (1) a process in which impurities such as inorganic substances and the like are removed by extraction with water (U.S. Pat. No. 5,008,364), (2) processes in which impurities such as inorganic substances and the like are removed by dissolution through washing a solution of the polymer with a large amount of water or a mixed solvent of water and acetone or the like (JP-A-58-101114 and JP-A-59-74125), and others.

Even the purified polyether sulfones obtained by these processes, however, have necessarily been products which meet demands of the market, relating to the field of electric and electronic parts, particularly to an application field in which a high level insulating ability in very thin films are required, including insulating films for multilayer boards, interlaminer insulating films for integrated circuits, and the like.

In view of the above problems, the present invention has a purpose that a solution of a polyether sulfone with a high purity and a polyether sulfone with a high purity, containing a less amount of inorganic substances such as alkali metal compounds, alkali metal halides and the like, useful in the field of electric and electronic parts or the like, particularly in an application field in which a high level insulating ability in very thin films are required, including insulating films for multilayer boards, interlaminer insulating films for integrated circuits and the like.

As the result of extensive researches for resolving the above problems, the present inventors have found the fact that purified polyether sulfones having a significantly lowered content of impurities such as inorganic substances and the like can easily be produced by a simple treatment that a solution of a crude polyether sulfone in an organic solvent is brought in contact with an adsorbent.

### SUMMARY OF THE INVENTION

The present invention provides a practically advantageous process for producing a purified polyether sulfone which comprises bringing a solution of a crude polyether sulfone in an organic solvent in contact with an adsorbent.

### DETAILED DESCRIPTION OF THE INVENTION

The invention is described below in detail.

As the crude polyether sulfone in the invention usually employed are polymers obtained by polycondensing a dihalogenophenyl compound with a bivalent phenol compound in an organic solvent and in the presence of an alkali metal compound or by polycondensing a dihalogenophenyl compound with a previously prepared salt of a bivalent phenol compound and an alkali metal compound.

Examples of the organic solvent used in the production of the crude polyether sulfone include sulfoxide solvents such as dimethylsulfoxide, hexamethylenesulfoxide and the like; amide solvents such as N,N-dimethylformamide, N,N-dimethylacetamide and the like; pyrrolidone solvents such as N-methyl-2-pyrrolidone, N-vinyl-2-pyrrolidone and the like; piperidone solvents such as N-methyl-2-piperidone and the like; 2-imidazolinone solvents such as 1,3-dimethyl-2-imidazolinone and the like; diphenyl compounds such as diphenyl ether, diphenyl sulfone and the like; halogenated compound solvents such as methylene chloride, chloroform, dichloroethane, tetrachloroethane, trichloroethylene and the like; lactone solvents such as γ-butyrolactone and the like; sulfolane solvents such as sulfolane and the like; and a mixture of two or more of them.

Examples of the alkali metal compound include alkali metal carbonates, alkali metal hydroxides, alkali metal hydrides, alkali metal alkoxides and the like. Amongst preferred are alkali metal carbonates such as potassium carbonate, sodium carbonate and the like and, in particular, preferred are anhydrous alkali metal carbonates such as anhydrous potassium carbonate, anhydrous sodium carbonate and the like.

Examples of the dihalogenodiphenyl compounds include dihalogenodiphenyl compounds having a sulfone group, for example, dihalogenodiphenyl sulfones such as 4,4′-dichlorodiphenyl sulfone, 4,4′-difluorodiphenyl sulfone and the like; bis(halogenophenylsulfonyl)benzenes such as 1,4-bis(4-chlorophenylsulfonyl)benzene, 1,4-bis(4-fluorophenylsulfonyl)benzene and the like; bis(halogenophenylsulfonyl)biphenyls such as 1,4-bis(4-chlorophenylsulfonyl)biphenyl, 1,4-bis(4-fluorophenylsulfonyl)biphenyl and the like; a mixture of two or more of them and the like. Amongst preferred are dihalogenodiphenyl sulfones such as 4,4′-dichlorodiphenyl sulfone, 4,4′-difluorodiphenyl sulfone and the like because of easier availability.

Examples of the bivalent phenol compound include, in addition to hydroquinone, catechol, resorcinol and 4,4′-biphenol, bis(4-hydroxyphenyl)alkanes such as 2,2-bis(4-hydroxyphenylpropane), 2,2-bis(4-hydroxyphenylmethane), 2,2-bis(4-hydroxyphenylethane)and the like; dihydroxydiphenyl sulfones such as 4,4′-dihydroxydiphenyl sulfone and the like; dihydroxydiphenyl ethers such as 4,4′-dihydroxydiphenyl ether and the like; compounds in which at least one hydrogen atom on the benzene ring in these compounds is substituted with lower alkyl such as methyl, ethyl, propyl and the like, lower alkoxy such as methoxy, ethoxy, propyloxy and the like, or halogen such as chlorine, bromine, fluorine and the like; a mixture of two or more of them, and the like. Particularly preferred are hydroquinone, 4,4′-biphenol, 2,2-bis(4-hydroxyphenylpropane), 4,4′-dihydroxydiphenyl ether, 4,4′-dihydroxydiphenyl sulfone and the like, because of costs and easier availability.

The dihalogenodiphenyl compound is usually used in equimolar amount based on the bivalent phenol compound. In order to accommodate to the molecular weight, the bivalent phenol compound can be used in a somewhat greater or smaller amount than the equimolar amount. Likewise, in order to accommodate to the molecular weight, a small amount of a monohalogenodiphenyl compound or a monovalent phenol compound can be added to a polymerization solution.

The reaction temperature for the polycondensation is preferably 140 to 340° C. When the polycondensation is carried out at a temperature higher than 340° C., there is a tendency that a polyether sulfone with a high purity may not be obtained because of decomposition of the polymer as the product. When the polycondensation is carried out at a temperature lower than 140° C., there is a tendency that a polymer having a high molecular weight may not be obtained.

A reaction mass containing a polyether sulfone and a large amount of inorganic substances such as alkali metal halides and others is produced in this manner. In the invention, a product formed by removing a large amount of inorganic substances and the organic solvent from the reaction mass is usually used as the crude polyether sulfone.

Specifically, for example, usually used crude polyether sulfone is a product obtainable by removing inorganic substances from the reaction solution through filtration, centrifugation, decantation, washing with water or the like and then adding a poor solvent to precipitate the polyether sulfone, a product obtainable by adding a poor solvent to the reaction mass to precipitate the polyether sulfone and then removing inorganic substances by washing with water or others, or the like.

When a polyether sulfone is substantially dissolved in the reaction mass, the mass itself may be used as a solution of a crude polyether sulfone in an organic solvent, but preferably a product formed by removing inorganic substances as above is used.

The invention is characterized in that a solution of a crude polyether sulfone in an organic solvent is brought in contact with an adsorbent. The organic solvent is preferably an organic polar solvent. Specific examples of the organic polar solvent include sulfoxide solvents such as dimethylsulfoxide, hexamethylenesulfoxide and the like; amide solvents such as N,N-dimethylformamide, N,N-dimethylacetamide and the like; pyrrolidone solvents such as N-methyl-2-pyrrolidone, N-vinyl-2-pyrrolidone and the like; piperidone solvents such as N-methyl-2-piperidone and the like; 2-imidazolinone solvents such as 1,3-dimethyl-2-imidazolinone and the like; diphenyl compounds such as diphenyl ether, diphenyl sulfone and the like; lactone solvents such as γ-butyrolactone and the like; sulfolane solvents such as sulfolane; a mixture of two or more of them; and the like. Amongst them, the amide solvents are preferred.

The adsorbent is not particularly limited. Examples include activated carbon, silica gel, silica-alumina complex, activated clay, activated alumina, diatomaceous earth, pearlite, cellulose, asbestos, carbon, a mixture of them and the like. Amongst them, diatomaceous earth and pearlite are preferred. Two or more of the adsorbent maybe used. Preferred specific surface area of the adsorbent is about 100 to 100,000 cm²/g.

The amount of the adsorbent is not particularly limited and usually it is about 0.01 to 30 times, preferably 0.1 to 10 times the weight of crude polyether sulfone. When the amount is less than 0.01 time by weight, there is a tendency that the purity of a purified polyether sulfone may become lowered. When the amount exceeds 30 times by weight, the effect on purification may not be high corresponding to the amount.

The temperature at which a solution of a crude polyether sulfone in an organic solvent is brought in contact with an adsorbent is not particularly limited and usually it is about 10 to 200° C., preferably about 30 to 150° C. The period of contact is not particularly limited and usually it is about 0.5 to 30 hours.

After a treatment for contact, the adsorbent is removed by, for example, filtration, centrifugation, decantation or the like, and the solvent is removed by, for example, distillation or the like to give a purified polyether sulfone which is desired in the invention.

Since, in the present invention, the product becomes a purified polyether sulfone with a high purity by the treatment for contact, a product after the step for removing the adsorbent is also useful as a solution containing a purified polyether sulfone with a high purity in an organic solvent.

In addition, not only a simple crude polyether sulfone but also a mixture thereof with another resin can be used in the invention and a resin mixture containing significantly lowered amount of impurities such as inorganic substances or the like can be produced therefrom by a similar treatment for contact. Examples of another resin include thermoplastic resins such as polyamides, polyesters, polyphenylene sulfides, polyether ketones, polycarbonates, polyether sulfones, polyphenyl ethers and their modification products, polyetherimides and the like, thermosetting resins such as phenol resins, epoxy resins, polyimide resins, cyanate resins and the like, as well as a mixture of two or more of them.

### EXAMPLES

The invention will be described with reference to Examples.

### Example 1

Into 900 g of N,N-dimethylacetamide was dissolved 100 g of a polyether sulfone (Sumikaexcel 5003P, manufactured by Sumitomo Chemical Co., Ltd., a polycondensation product of 4,4′-dihydroxydiphenyl sulfone with 4,4′-dihalodiphenyl sulfone; reduced viscosity: 0.5 (in DMF, 1 g/dl, 25° C.)) at 100° C. with stirring. Then, 5 g of Kyowaad #700 (a diatomaceous earth adsorbent, manufactured by Kyowa Chemical Ind., Ltd.) was added and the mixture was stirred at the same temperature for 30 minutes. The obtained solution was filtered through a filter paper precoated with 22 g of Radiolite #100 (a diatomaceous earth adsorbent, manufactured by Showa Chemical Ind., Ltd.) to give a filtrate.

The obtained filtrate was quantified for the alkali metal content and the result of content in solution and that converted to content in resin were expressed by values converted to potassium. The quantification was carried out by ICP-AES method after ashing and dissolution in an acid. The results are shown in Table 1.

### Example 2

Into 190 g of γ-butyrolactone was dissolved 10 g of the same polyether sulfone as that used in Example 1 at 100° C. with stirring. The obtained solution was cooled to 50° C. After adding 5 g of dry ice, the solution was stirred at 50° C. for 2 hours. Then, 2 g of Kyowaad #700 was added and the mixture was stirred for additional 30 minutes. The obtained solution was filtered through a filter paper precoated with 10 g of Radiolite #100 to give a filtrate. The quantification was carried out in the same manner as that in Example 1. The results are shown in Table 1.

### Example 3

Into 190 g of γ-butyrolactone was dissolved 10 g of the same polyether sulfone as that used in Example 1 at 100° C. with stirring. Then, 2 g of Kyowaad #700 was added and the mixture was stirred for 30 minutes. The obtained solution was filtered through a filter paper precoated with 10 g of Radiolite #100 to give a filtrate. The quantification was carried out in the same manner as that in Example 1. The results are shown in Table 1.

### Example 4

Example 3 was substantially repeated except that Kyowaad #700 was not used to give a filtrate. The quantification was carried out in the same manner as that in Example 1. The results are shown in Table 1.

### Comparative Example 1

After extracting 10 g of the same polyether sulfone as that used in Example 1 with 200 g of water in Soxhlet apparatus for 24 hours, the obtained powders were dried under reduced pressure at 50° C. for 24 hours to give powders of the polyether sulfone. The quantification was carried out in the same manner as that in Example 1. The results are shown in Table 1.

### Comparative Example 2

The quantification was carried out in the same manner as that in Example 1 using the same polyether sulfone as that used in Example 1. The results are shown in Table 1.

TABLE 1

| | Solution of polyether | Polyether sulfone |
|---|---|---|
| | sulfone in solvent | in resin |
| Example No. | K (ppm) | K (ppm) |
| Example 1 | <1 | <10 |
| Example 2 | 3 | 60 |
| Example 3 | 2 | 40 |
| Example 4 | 31 | 620 |
| Comparative | | 1000 |
| example 1 | | |
| Comparative | | 1400 |
| example 2 | | |

According to the invention, a purified polyether sulfones having a significantly lowered content of impurities such as inorganic substances and the like can easily be produced by a simple treatment that a solution of a crude polyether sulfone in an organic solvent is brought in contact with an adsorbent.

Since the purified polyether sulfone obtained in the invention has a significantly lowered content of impurities such as inorganic substances and the like, the purified polyether sulfone is useful in the field of electric and electronic parts or the like, particularly in an application field in which a high level insulating ability in very thin films are required, including insulating films for multilayer boards and interlaminer insulating films for integrated circuits and the like.

What is claimed is:

1. A process for producing a purified polyether sulfone which comprises bringing a solution of a crude polyether sulfone in an organic solvent in contact with an adsorbent.

2. The process according to claim 1, wherein the organic solvent is at least one polar solvent selected from the group consisting of sulfoxide solvents, amide solvents, pyrrolidone solvents, piperidone solvents, 2-imidazolinone solvents, diphenyl compounds, hexamethylene sulfoxide, γ-butyrolactone and sulfolane.

3. The process according to claim 1, wherein the adsorbent is at least one selected from the group consisting of activated carbon, silica gel, silica-alumina complex, activated clay, activated alumina, diatomaceous earth, pearlite, cellulose and asbestos.

4. The process according to claim 1, wherein the crude polyether sulfone is a polymer obtained by polycondensing at least one bisphenol selected from the group consisting of hydroquinone, 4,4′-biphenol, 2,2-bis(4-hydroxyphenylpropane), 4,4′-dihydroxydiphenyl ether and 4,4′-dihydroxydiphenyl sulfone with 4,4′-dihalodiphenyl sulfone in an organic solvent and in the presence of an alkali metal compound.

5. The process according to claim 4, wherein the alkali metal compound is an anhydrous alkali metal carbonate.

6. A solution of a purified polyether sulfone is an organic solvent obtained by a process according to claim 1.

7. A purified polyether sulfone obtained by removing the solvent from the solution of a purified polyether sulfone in an organic solvent according to claim 6.
